(19) United States
(12) Patent Application Publication
(10) Pub. No.: US 2023/0273835 A1
(43) Pub. Date: Aug. 31, 2023

(54) Computer System and Arithmetic Processing Method

(71) Applicant: Nippon Telegraph and Telephone Corporation, Tokyo (JP)

(72) Inventors: Yuki Arikawa, Tokyo (JP); Kenji Tanaka, Tokyo (JP); Tsuyoshi Ito, Tokyo (JP); Takeshi Sakamoto, Tokyo (JP)

(21) Appl. No.: 18/006,934

(22) PCT Filed: Aug. 5, 2020
(86) PCT No.: PCT/JP2020/030020

§ 371 Date: Jan. 26, 2023

(51) Int. Cl. G06F 9/50

(52) U.S. Cl. CPC G06F 9/5072; G06F 9/505

(57) ABSTRACT

A computer system according to the present invention includes N (N is an integer of 2 or more) data output devices, a transmission control device, and an arithmetic device, in which the arithmetic device executes predetermined arithmetic processing on data collected from the N data output devices via a communication network connecting the data output devices and the arithmetic device to each other, the transmission control device controls transmission timing of data output from the N data output devices according to a processing content of the predetermined arithmetic processing executed by the arithmetic device, and the N data storage devices are configured to output the data on the basis of the transmission timing notified by the transmission control device.

### CROSS-REFERENCE TO RELATED APPLICATIONS

This application is a national phase entry of PCT Application No. PCT/JP2020/030020, filed on Aug. 5, 2020, which application is hereby incorporated herein by reference.

### TECHNICAL FIELD

The present invention relates to a computer system in which an arithmetic device and a plurality of storage devices are connected via a communication network, and the entire system operates in cooperation.

### BACKGROUND

Technological innovation has progressed in many fields such as in machine learning, artificial intelligence (AI), and the Internet of Things (IoT), and the sophistication of services and the provision of added values thereto is being actively performed by utilizing various information and data. In such processing, it is necessary to perform a large amount of calculation, and an information processing infrastructure therefor is essential.

For example, Non Patent Literature 1 points out that although attempts to update an existing information processing infrastructure have been developed, it is also a fact that modern computers have not been able to cope with rapidly increasing data, and in order to achieve further evolution in the future, a “post-Moore technology” beyond Moore's Law needs to be established.

As the post-Moore technology, for example, Non Patent Literature 2 discloses a technology called flow-centric computing. In flow-centric computing, a new concept of moving data to a place where a calculation function exists and performing processing has been introduced, instead of the conventional idea of computing in which processing is performed at a place where data exists.

### CITATION LIST

### Non Patent Literature

Non Patent Literature 1: “NTT Technology Report for Smart World 2020,” Nippon Telegraph and Telephone Corporation, 2020, <URL:https://www.rd.ntt/_assets/pdf/techreport/NTT_TRFSW_2020_EN_W.pdf>
Non Patent Literature 2: R. Takano and T. Kudoh, “Flow-centric computing leveraged by photonic circuit switching for the post-moore era,” Tenth IEEE/ACM International Symposium on Networks-on-Chip (NOCS), Nara, 2016, pp. 1-3, <URL:https://ieeexplore.ieee.org/abstract/document/7579339>
Non Patent Literature 3: Saki Hatta, Nobuyuki Tanaka, and Takeshi Sakamoto, “Low Latency Dynamic Bandwidth Allocation Method with High Bandwidth Efficiency for TDM-PON,” NTT Technical Review, Vol. 15 No. 4 Apr. 2017, <URL:https://www.ntt-review.jp/archive/natechnical.php?contents=ntr201704rai_s.html>

### SUMMARY

### Technical Problem

In order to realize flow-centric computing as described above, not only is a broadband communication network necessary for data movement required, but also data movement may not be able to be efficiently performed unless the communication network is efficiently controlled at the same time.

Non Patent Literature 3 discloses a data transmission/reception control method between devices to which dynamic bandwidth allocation (DBA) used as a technology such as fiber to the home (FTTH) is applied, but does not disclose a technology for efficiently performing data movement between a plurality of data generation devices and a higher-level arithmetic device.

Embodiments of the present invention have been made to solve the above-described problems, and an object thereof is to provide a computing system capable of efficiently moving data between a storage device and an arithmetic device connected via a communication network.

### Solution to Problem

In order to solve the above-described problem, according to embodiments of the present invention, there is provided a computer system including: N (N is an integer of 2 or more) data output devices; a transmission control device; and an arithmetic device, in which the arithmetic device executes predetermined arithmetic processing on data collected from the N data output devices via a communication network connecting the data output device and the arithmetic device to each other, the transmission control device controls transmission timing of the data output from the N data output devices according to a processing content of the predetermined arithmetic processing executed by the arithmetic device, and the N data output devices are configured to output the data on the basis of the transmission timing notified by the transmission control device.

In order to solve the above-described problem, according to embodiments of the present invention, there is provided an arithmetic processing method executed in a computer system including N (N is an integer of 2 or more) data output devices, a transmission control device, and an arithmetic device, the arithmetic processing method including: notifying, by the transmission control device, transmission timing of data output from the N data output devices according to a processing content of the predetermined arithmetic processing executed by the arithmetic device; outputting, by the N data output devices, the data on the basis of the transmission timing notified by the transmission control device; and executing, by the arithmetic device, the predetermined arithmetic processing on the data collected from the N data output devices via a communication network connecting the data output device and the arithmetic device to each other.

### Advantageous Effects of Embodiments of Invention

According to embodiments of the present invention, it is possible to provide a computing system that efficiently moves data between a storage device and an arithmetic device connected via a communication network.

### BRIEF DESCRIPTION OF THE DRAWINGS

FIG. 1 is a block diagram illustrating a configuration of a computer system according to a first embodiment.

FIG. 2 is a diagram for describing processing of a transmission control device in the computer system according to the first embodiment.

FIG. 3 is a block diagram illustrating a configuration of the computer system according to the first embodiment.

FIG. 4 is a flowchart illustrating an operation of the transmission control device in the computer system according to the first embodiment.

FIG. 5 is a block diagram illustrating a configuration of a computer system according to a second embodiment.

FIG. 6 is a diagram for describing processing of a transmission control device in the computer system according to the second embodiment.

FIG. 7 is a flowchart illustrating an operation of the transmission control device in the computer system according to the second embodiment.

FIG. 8 is a flowchart illustrating an operation of the transmission control device in the computer system according to the second embodiment.

FIG. 9 is a block diagram illustrating a configuration of a computer system according to a third embodiment.

FIG. 10 is a block diagram illustrating a configuration of the computer system according to the third embodiment.

FIG. 11 is a flowchart illustrating an operation of a transmission control device in the computer system according to the third embodiment.

FIG. 12 is a block diagram illustrating a hardware configuration of a computer system according to an embodiment of the present invention.

FIG. 13 is a block diagram illustrating a configuration of a conventional computer system.

### DETAILED DESCRIPTION OF ILLUSTRATIVE EMBODIMENTS

Hereinafter, preferred embodiments of the present invention will be described with reference to the drawings. The present invention is not limited to the following embodiments.

### First Embodiment

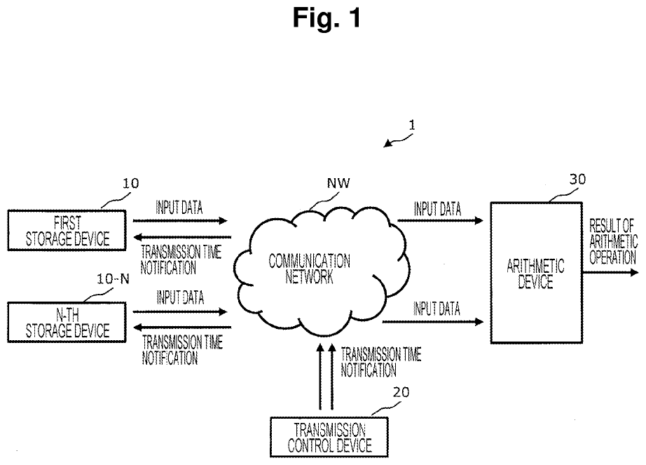

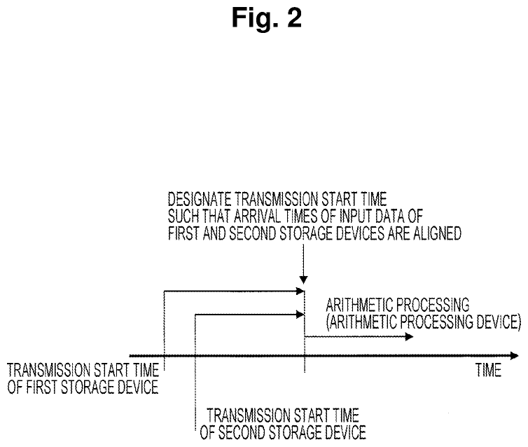

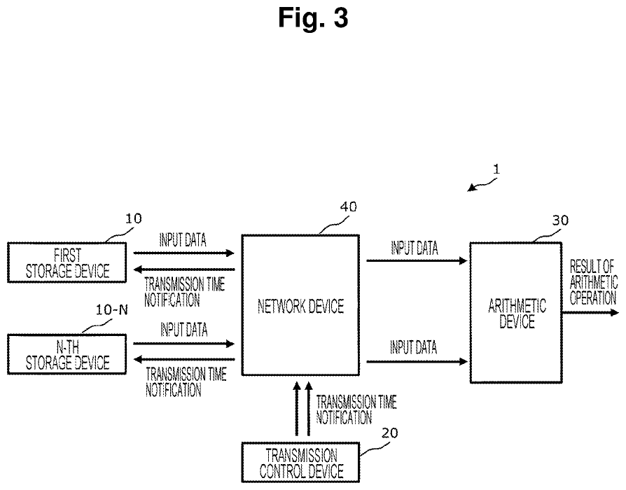

A configuration of a computer system 1 according to a first embodiment of the present invention will be described with reference to FIGS. 1 to 3. FIGS. 1 and 3 are block diagrams illustrating a configuration of the computer system according to the first embodiment. FIG. 2 is a diagram for describing processing of a transmission control device in the computer system according to the first embodiment.

[Computer System]

The computer system 1 of the present embodiment includes N first to N-th storage devices (10 to 10-N) (N is an integer of 2 or more), a transmission control device 20, and an arithmetic device 30, and the first to N-th storage devices (10 to 10-N) and the arithmetic device 30 are connected by a communication network. As a whole, based on a command from the transmission control device 20, predetermined arithmetic operation or processing is performed on data output from the first to N-th storage devices (10 to 10-N) via the communication network, and a result of the arithmetic operation is output.

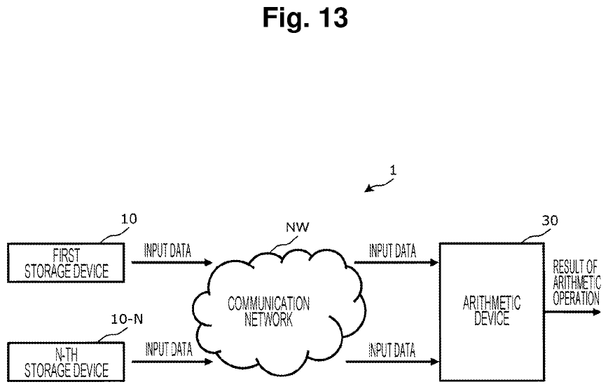

A difference from the conventional computer system 1 illustrated in FIG. 13 is that a transmission control device 20 is provided. In the conventional computer system 1, the storage device 10 does not control the transmission timing so that the time at which the transmitted data arrives at the arithmetic device 30 is the same in consideration of the network delay, but in the computer system 1 of the present embodiment, the transmission control device 20 can designate a transmission start time to the storage device 10.

[Storage Device]

The storage device 10 is a data output device having a function of storing data and transmitting the stored data at a transmission start time notified by the transmission control device 20. As the data output device, a data generation device having a function of generating data and transmitting the generated data at a transmission start time designated by the transmission control device 20 may be used.

The storage device 10 corresponds to a device specialized in data holding such as a data storage or a data server, a general-purpose computer having a storage function in general, or the like. Furthermore, the data generation device corresponds to a device having a function of generating data, such as a sensor terminal. In the present embodiment, a storage device 10 that outputs stored data is used as the data output device.

Note that the data generation device holds the data until the transmission start time designated by the transmission control device 20. The data may be stored in an external storage device 10 or the like.

[Transmission Control Device]

The transmission control device 20 has a function of controlling the transmission timing of the first to N-th storage devices (10 to 10-N) such that the input data of the first to N-th storage devices (10 to 10-N) used for the arithmetic operation arrives at the arithmetic device 30 at substantially the same time when the arithmetic device 30 performs an arithmetic operation between the pieces of input data. Specifically, as illustrated in FIG. 2, when the arithmetic processing executed by the arithmetic device 30 is addition processing of data output from the first storage device and the second storage device, a transmission start time at which each storage device 10 outputs data is designated in consideration of a difference in delay time of the communication network. Thus, since the data holding time in the arithmetic device 30 is shortened, it is possible to realize efficient arithmetic processing with a small waiting time in arithmetic processing.

The delay time of the communication network can be obtained by measuring a round trip time which is a time required for transmission and reception of data between devices connected via a communication network widely known in the alt.

As illustrated in FIG. 3, a network device such as a network switch or a router may be included between the storage device 10 and the arithmetic device 30. In this case, the communication network delay may be measured to include the internal delay of the device.

[Arithmetic Device]

The arithmetic device 30 has a function of performing arithmetic processing on data output from the storage device 10. The arithmetic device 30 may be realized by software on a CPU or a GPU, or may be realized by a large scale integration (LSI) circuit formed in a field programmable gate array (FPGA) or an application specific integrated circuit (ASIC).

In the above example, an example has been described in which data is output from each storage device 10 by designating the data transmission start time to each storage device 10, but the trigger for starting the transmission is not limited thereto. For example, the output of data may be started with the arrival of a packet indicating transmission permission transmitted from the transmission control device 20 as a trigger.

In the above example, the input data is collected from all the first to N-th storage devices (10 to 10-N), but it is not always necessary to set all the first to N-th storage devices (10 to 10-N) as data collection targets. For example, input data may be collected for some storage devices 10, and in this case, the transmission control device 20 only needs to notify the corresponding storage device 10 of the transmission start time.

In the above example, the transmission start time is designated in consideration of only the delay of the communication network. However, the information used to designate the transmission start time is not limited to the communication network delay. For example, in a case where the processing load in the arithmetic device 30 is high, the transmission start time may be designated such that the data arrives at the timing when the processing load is reduced.

In a case where there are a plurality of processing target tasks, such as a case where there are two groups of designated device group A and device group B among the storage devices 10 or the data generation devices, and the arithmetic device 30 can simultaneously process a plurality of tasks, for example, when the arithmetic device 30 is configured by a multi-core processor and can simultaneously execute processing of the device group A and the device group B, the transmission control device 20 only needs to be configured to designate the transmission start time in consideration of the communication network delay with respect to the storage devices 10 which are an output source of target data to be processed by the arithmetic device 30 at the same time.

Note that the communication network is intended for any network topology or configuration. For example, there are network topologies such as a tree type, a star type, a torus structure, and a passive optical network (PON) used in fiber to the home (FTTH).

### Operation of First Embodiment

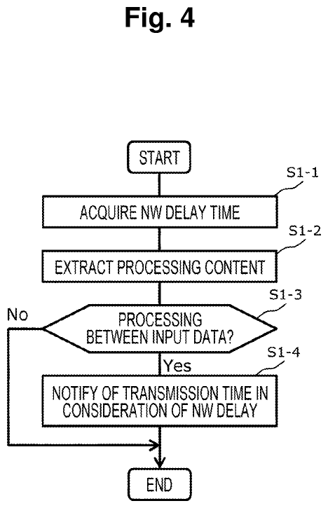

Next, the operation of the arithmetic processing method of the transmission control device 20 in the computer system 1 according to the first embodiment will be described with reference to FIG. 4. FIG. 4 is a flowchart illustrating an operation of the transmission control device in the computer system according to the first embodiment.

First, the transmission control device 20 measures or acquires a communication network delay time (step S1-1). The delay time of the communication network can be obtained by measuring a round trip time which is a time required for transmission and reception of data between devices connected via a communication network widely known in the art.

Next, the transmission control device 20 extracts the processing content of arithmetic processing executed by the computer system 1 (step S1-2). The processing content of the arithmetic processing may be designated by a user who desires to perform the arithmetic processing when performing the arithmetic processing, or may be designated in advance in the transmission control device 20.

As a result of the extraction, it is determined whether or not the arithmetic processing is arithmetic processing that simultaneously uses data of a plurality of data output sources, such as an arithmetic operation between pieces of data output from the storage device 10 (step S1-3).

As a result of the above determination, in the case of arithmetic processing that simultaneously uses data of a plurality of data output sources, a transmission start time in consideration of a communication network delay is obtained such that the data arrives at the arithmetic device 30 at substantially the same time, and the storage device 10 is notified of the transmission start time (step 1-4).

The storage device 10 outputs the data stored in each storage device 10 to the arithmetic device 30 on the basis of the transmission start time notified by the transmission control device 20.

The arithmetic device 30 executes predetermined arithmetic processing on data input from the storage device 10.

### Effect of First Embodiment

As described above, in the computer system 1 of the present embodiment, when the arithmetic device 30 performs the arithmetic operation between the pieces of input data, the transmission start times in the respective storage devices 10 are designated such that the input data of the first to N-th storage devices (10 to 10-N) used for the arithmetic operation arrives at the arithmetic device 30 at substantially the same time.

Thus, in the arithmetic device 30, the waiting time from the arrival of certain data to the arrival of the other data can be shortened, so that the memory amount of the arithmetic device 30 can be reduced as compared with the computer system 1 including the memory in the arithmetic device 30 to store and hold the data.

In addition, since it is possible to efficiently move data between the storage device 10 and the arithmetic device 30 by shortening a waiting time of data necessary for processing between the storage device 10 and the arithmetic device 30, it is possible to shorten a time from reading of data from the storage device 10 to completion of predetermined processing as compared with the conventional computer system 1.

### Second Embodiment

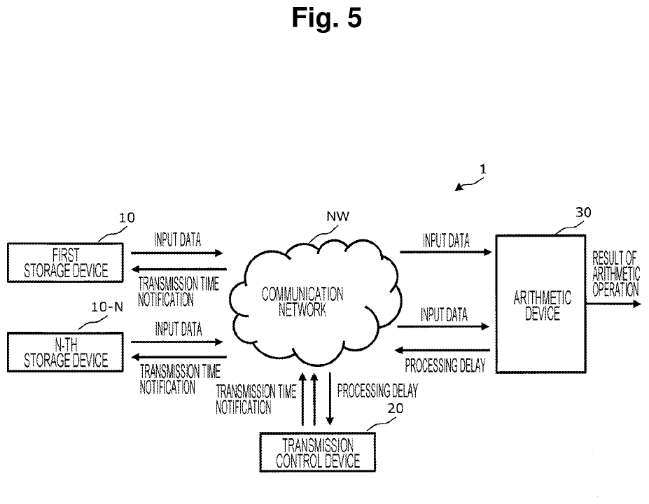

A computer system 1 according to a second embodiment will be described with reference to FIGS. 5 to 8. FIG. 5 is a block diagram illustrating a configuration of the computer system according to the first embodiment. The configuration of the computer system according to the second embodiment is similar to the configuration of the computer system 1 according to the first embodiment, but is different in that information on a processing delay is acquired from the arithmetic device 30, and each storage device 10 is notified of a transmission time in consideration of the information on the processing delay in addition to the network delay.

### Operation of Second Embodiment

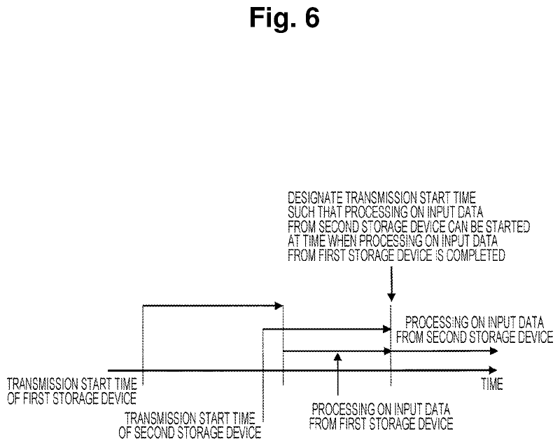

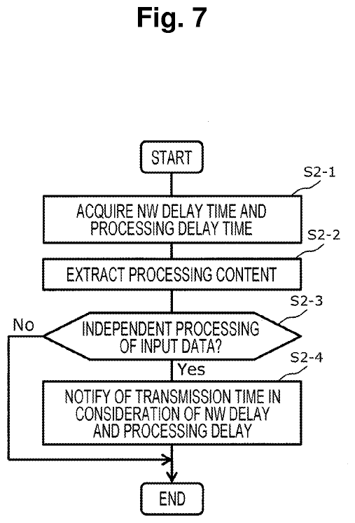

FIG. 6 is a diagram for describing processing of the transmission control device 20 in the computer system 1 according to the second embodiment. FIG. 7 is a flowchart illustrating an operation of the transmission control device in the computer system according to the second embodiment.

In the second embodiment, in the case of arithmetic processing that continuously uses data of a plurality of data output sources, the data transmission timing in each storage device 10 is controlled such that the data from the second storage device can arrive at the arithmetic device 30 and processing (second arithmetic processing) on the data from the second storage device can be started at the end of processing (first arithmetic processing) using the data of the first storage device.

First, the transmission control device 20 measures or acquires a communication network delay time, and measures or acquires a processing delay time in the arithmetic device 30 (step S2-1).

Note that the delay time of the communication network is obtained by measuring a round trip time which is a time required for transmission and reception of data between devices connected via a communication network widely known in the alt.

As the processing delay time in the arithmetic device 30, for the processing assumed in advance, a processing delay time measured in advance by the arithmetic device 30 before the operation of the computer system 1 such as at the time of initial setting is held as an initial setting value in the transmission control device 20, and the value can be used.

In addition, even if it is not held as the initial setting value, it is also possible to use an initial setting value of similar processing, or in a case where there is a record of performing the processing in the past, it is also possible to store a processing delay at that time and use a value used at that time.

In addition, it is also possible to estimate the processing delay in the arithmetic device 30 from the processing delay in a case where the processing is performed in the transmission control device 20 in consideration of the difference in calculation performance between the transmission control device 20 and the arithmetic device 30, and use the value.

Next, the transmission control device 20 extracts the processing content to be executed by the computer system 1 (step S2-2). The processing content of the arithmetic processing may be designated by a user who desires to perform the arithmetic processing when performing the arithmetic processing, or may be designated in advance in the transmission control device 20.

As a result of the extraction, it is determined whether or not the processing on the data output from the storage device 10 is independent, that is, whether or not the processing is sequential arithmetic processing in which the processing for the data from a certain first storage device is executed and then the processing is continuously performed for the next data from the second storage device instead of simultaneously using the data of a plurality of data output sources (step S2-3).

As a result of the above determination, in the case of arithmetic processing that continuously uses data of a plurality of data output sources, a transmission start time in the storage device 10 is obtained in consideration of the communication network delay and the arithmetic processing delay such that the next data from the second storage device can arrive at the arithmetic device 30 and processing on the data from the second storage device can be started at the end of processing using the data of the first storage device, and is notified to the storage device 10 (step S2-4). For example, the data transmission start time of the second storage device is notified such that the next data from the second storage device arrives at the arithmetic device 30 at substantially the same time as the end of the processing on the input data from the first storage device.

The storage device 10 outputs the data stored in each storage device 10 to the arithmetic device 30 on the basis of the transmission start time notified by the transmission control device 20.

The arithmetic device 30 executes predetermined arithmetic processing on data input from the storage device 10.

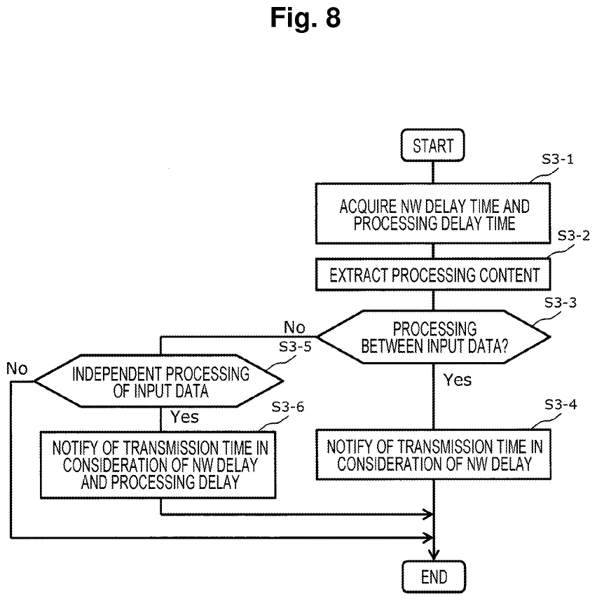

As illustrated in FIG. 8, the flowchart of FIG. 7 may be combined with the flowchart of FIG. 4. FIG. 8 is a flowchart illustrating an operation of the transmission control device in the computer system according to the second embodiment.

In FIG. 8, after it is determined whether or not the arithmetic processing is arithmetic processing that simultaneously uses data of a plurality of data output sources, such as an arithmetic operation between pieces of data output from the storage device 10 (step S3-3), it is determined whether processing on data of a plurality of data output sources is independent (step S3-5).

After the processing content of the arithmetic processing is determined, similarly to the processing after the determination in FIGS. 4 and 7 (steps S1-4 and S2-4), the transmission start time in the storage device 10 is obtained in consideration of the communication network delay and the arithmetic processing delay, and is notified to the storage device 10 (steps S3-4 and S3-6).

### Effect of Second Embodiment

As described above, in the case of the arithmetic processing that continuously uses the data of the plurality of data output sources, the computer system 1 of the present embodiment designates the transmission start time in consideration of the communication network delay and the arithmetic processing delay such that the data from the second storage device can arrive at the arithmetic device 30 and processing on the data from the second storage device can be started at substantially the same time as the end of processing using the data of the first storage device.

Thus, in the arithmetic device 30, since the next data does not arrive while certain data is being processed, the memory amount of the arithmetic device 30 can be reduced as compared with the conventional computer system 1.

In addition, since it is possible to efficiently perform data movement between the storage device 10 and the arithmetic device 30 by suppressing an increase in delay time in the arithmetic device 30, an increase in idle time of the arithmetic device 30, and the like, such as an early arrival of data necessary for processing between the storage device 10 and the arithmetic device 30 or waiting for the arrival of data necessary for processing, it is possible to shorten a time from reading of data from the storage device 10 to completion of predetermined processing as compared with the conventional computer system 1.

### Third Embodiment

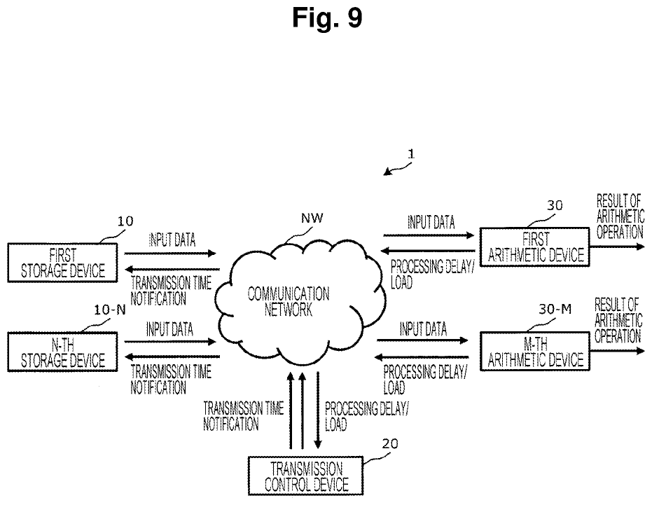

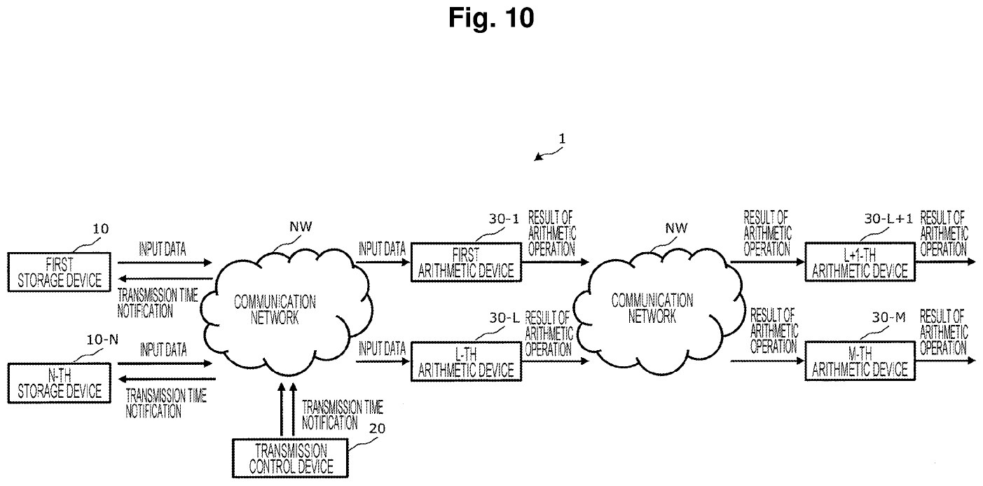

A configuration of a computer system 1 according to a third embodiment of the present invention will be described with reference to FIGS. 9 and 10. FIGS. 9 and 10 are block diagrams illustrating a configuration of the computer system according to the third embodiment.

[Computer System]

The computer system 1 of the present embodiment includes first to N-th storage devices (10 to 10-N) (N is an integer of 2 or more), a transmission control device 20, and M first to M-th arithmetic devices (30 to 30-M) (M is an integer of 2 or more), and the devices are connected by a communication network.

The difference from the first and second embodiments is that the arithmetic device 30 is configured by first to M-th arithmetic devices (30 to 30-M) (M is an integer of 2 or more). As a whole, based on a command from the transmission control device 20, the arithmetic device (30 to 30-M) designated by the transmission control device 20 performs predetermined arithmetic operation or processing on data output from the first to N-th storage devices (10 to 10-N) via the communication network, and outputs a result of the arithmetic operation.

[Storage Device]

The configuration of the storage device 10 is similar to that of the first and second embodiments.

[Transmission Control Device]

The transmission control device 20 has a function of designating an arithmetic device (30 to 30-M) that performs arithmetic processing, in addition to the function of controlling the transmission timing of the first to N-th storage devices (10 to 10-N) described in the first and second embodiments.

A plurality of arithmetic devices 30 can be designated to perform parallel processing. When the arithmetic device 30 is designated, the arithmetic device 30 can also be designated in consideration of the congestion status of the communication network from the storage device 10 to the arithmetic device 30.

[Arithmetic Device]

The configurations of the first to M-th arithmetic devices (30 to 30-M) are similar to those of the first and second embodiments.

In the above example, the storage device 10 and the first to M-th arithmetic devices (30 to 30-M) are connected via the communication network. However, a plurality of arithmetic devices 30 may be further provided at a subsequent stage of the first to M-th arithmetic devices via the communication network. For example, as illustrated in FIG. 10, the storage device 10 and the first to L-th arithmetic devices (L is an integer of 2 or more) may be connected via a communication network, and the first to L-th arithmetic devices and the L-F i-th to M-th arithmetic devices may be connected via a communication network. As described above, when the arithmetic device 30 is connected in multiple stages via the communication network, the transmission control device 20 designates the transmission start time of the storage device 10 using each communication network delay, the processing delay of the arithmetic device 30, and the load information of the arithmetic device 30.

It is not necessary that all the arithmetic devices 30 have similar arithmetic performance. For example, in a case where there is a difference in arithmetic performance, the transmission control device 20 may designate the transmission start time in consideration of the performance difference.

### Operation of Third Embodiment

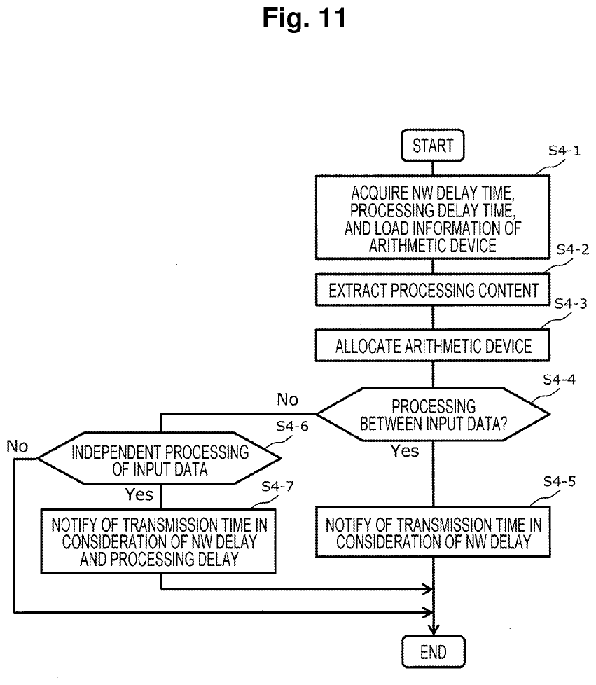

Next, the operation of the arithmetic processing method of the transmission control device 20 in the computer system 1 according to the third embodiment will be described with reference to FIG. 11. FIG. 11 is a flowchart illustrating an operation of the transmission control device in the computer system according to the third embodiment.

A difference from the first and second embodiments is that load information of the arithmetic device 30 is acquired (step S4-1), and which arithmetic device among the first to M-th arithmetic devices (30 to 30-M) is allocated to perform processing on the basis of the acquired information (S4-3).

The determination processing of the processing content of the arithmetic processing and the processing after the determination (steps S4-4, 5, 6, and 7) are similar to those described in the first and second embodiments.

### Effect of Third Embodiment

In the third embodiment, in addition to the effects described in the first and second embodiments, the input data can be distributed to the arithmetic device 30 by dynamically allocating the arithmetic device 30 with a low load to the input data in consideration of the load information of the arithmetic device 30. Therefore, the calculation resources of the arithmetic device 30 can be efficiently used as compared with the conventional computer system 1.

[Hardware Configuration of Computer System]

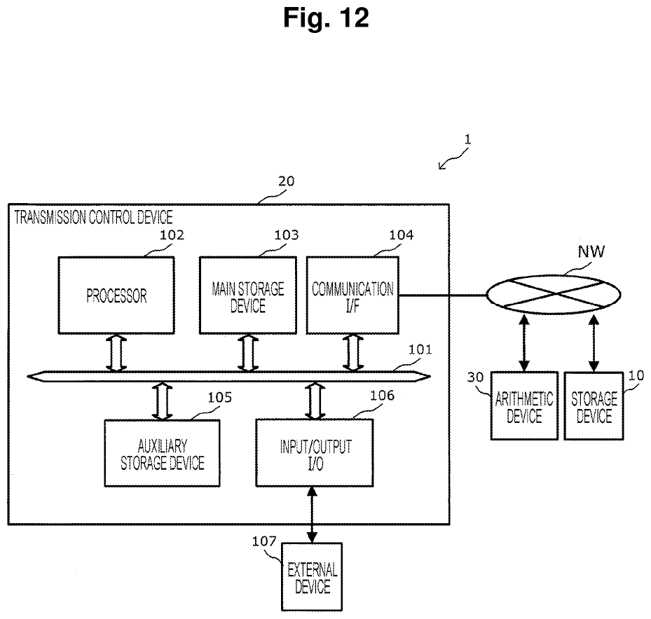

Next, an example of a hardware configuration of the computer system 1 having the above-described configuration will be described with reference to FIG. 12.

As illustrated in FIG. 1i, the transmission control device 20 of the computer system 1 can be realized by, for example, a computer including a processor 102, a main storage device 103, a communication interface 104, an auxiliary storage device 105, and an input/output I/O 106 connected via a bus 101, and a program for controlling these hardware resources. The transmission control device 20 is connected to an arithmetic device 30 and a storage device 10 via a communication network NW.

The main storage device 103 is realized by, for example, a semiconductor memory such as SRAM, DRAM, and ROM. The main storage device 103 realizes the storage unit described in FIG. 1 and the like.

In the main storage device 103, a program for the processor 102 to perform various controls and arithmetic operations is stored in advance. The function of the arithmetic processing unit is realized by the processor 102 and the main storage device 103.

The communication interface 104 is an interface circuit for communicating with the storage device 10 via the communication network NW. The transmission control device 20 notifies the storage device 10 connected via the communication interface 104 of the data transmission timing, and the arithmetic device 30 collects input data to be subjected to arithmetic operation from the storage device 10 via the communication network NW.

As the communication interface 104, for example, an interface and an antenna compatible with wireless data communication standards such as LTE, 3G, wireless LAN, and Bluetooth (registered trademark) are used. The communication network NW includes, for example, a wide area network (WAN), a local area network (LAN), the Internet, a dedicated line, a wireless base station, a provider, and the like.

[oils] The auxiliary storage device 105 includes a readable and writable storage medium and a drive device for reading and writing various types of information such as programs and data from and to the storage medium. In the auxiliary storage device 105, a semiconductor memory such as a hard disk or a flash memory can be used as a storage medium.

The auxiliary storage device 105 has a program storage area for storing a program for the arithmetic device 30 to perform arithmetic processing. Furthermore, the auxiliary storage device 105 may have, for example, a backup area for backing up the above-described data, programs, and the like. The auxiliary storage device 105 can store, for example, an arithmetic processing program.

The input/output I/O 106 includes an I/O terminal that inputs a signal from the external device 107 and outputs a signal to the external device 107.

Note that the transmission control device 20 may be realized not only by one computer but also distributed by a plurality of computers connected to each other via the communication network NW. In addition, the processor 102 may be realized by a large scale integration (LSI) circuit formed in a field programmable gate array (FPGA) or an application specific integrated circuit (ASIC).

In particular, the transmission control device 20 can be configured using a rewritable gate array such as an FPGA. In this case, the computer system 1 capable of supporting various applications can be realized.

### Extension of Embodiment

Although the present invention has been described above with reference to the embodiments, the present invention is not limited to the above embodiments. Various changes that can be understood by those skilled in the art can be made in the configuration and details of the present invention within the scope of the present invention. In addition, each embodiment can be implemented in any combination within a range not contradictory.

### REFERENCE SIGNS LIST

1 Computer system
10, 10-N Storage device
20 Transmission control device
30, 30-M Arithmetic device
101 Bus
102 Processor
103 Main storage device
104 Communication interface
105 Auxiliary storage device
106 Input/output I/O
107 External device.

1-8. (canceled)

9. A computer system comprising:
N data output devices, wherein N is an integer of 2 or more;
a transmission control device; and
an arithmetic device, wherein the arithmetic device is configured to execute predetermined arithmetic processing on data collected from the N data output devices via a communication network connecting the N data output devices and the arithmetic device to each other, wherein the transmission control device is configured to control transmission timing of the data output from the N data output devices according to a processing content of the predetermined arithmetic processing executed by the arithmetic device, and wherein the N data output devices are configured to output the data on a basis of the transmission timing as notified by the transmission control device.

10. The computer system according to claim 9, wherein the transmission control device is configured to control the transmission timing of the N data output devices such that the data output from the N data output devices arrives at the arithmetic device at substantially a same time, in consideration of a delay of the communication network, when the predetermined arithmetic processing executed by the arithmetic device is an arithmetic operation between the pieces of data collected from the N data output devices.

11. The computer system according to claim 9, wherein the transmission control device is configured to control the transmission timing of the N data output devices such that each arithmetic processing executed on the data output from the N data output devices is continuously executed and the data used for second arithmetic processing executed next to first arithmetic processing arrives at the arithmetic device at substantially a same time as an end of the first arithmetic processing in consideration of a delay of the communication network and a processing delay of the arithmetic processing when the predetermined arithmetic processing executed by the arithmetic device continuously executes independent arithmetic processing on each of the pieces of data collected from the N data output devices.

12. The computer system according to claim 9, further comprising:
M arithmetic devices, wherein M is an integer of 2 or more, and wherein the transmission control device is configured to distribute the data collected from the N data output devices to the M arithmetic devices on a basis of load information of the arithmetic device.

13. An arithmetic processing method executed in a computer system including N data output devices, a transmission control device, and an arithmetic device, N being an integer of 2 or more, the arithmetic processing method comprising:
notifying, by the transmission control device, transmission timing of data output from the N data output devices according to a processing content of predetermined arithmetic processing executed by the arithmetic device;
outputting, by the N data output devices, the data on a basis of the transmission timing notified by the transmission control device; and
executing, by the arithmetic device, the predetermined arithmetic processing on the data collected from the N data output devices via a communication network connecting the N data output device and the arithmetic device to each other.

14. The arithmetic processing method according to claim 13, further comprising:
controlling, by the transmission control device, the transmission timing of the N data output devices such that the data output from the N data output devices arrives at the arithmetic device at substantially the same time, in consideration of a delay of the communication network, when the predetermined arithmetic processing executed by the arithmetic device is an arithmetic operation between the pieces of data collected from the N data output devices.

15. The arithmetic processing method according to claim 13, further comprising:
controlling, by the transmission control device, the transmission timing of the N data output devices such that each arithmetic processing executed on the data output from the N data output devices is continuously executed, and the data used for second arithmetic processing executed next to first arithmetic processing arrives at the arithmetic device at substantially a same time as an end of the first arithmetic processing in consideration of a delay of the communication network and a processing delay of the arithmetic processing when the predetermined arithmetic processing executed by the arithmetic device continuously executes independent arithmetic processing on each of the pieces of data collected from the N data output devices.

16. The arithmetic processing method according to any one of claim 13, wherein the computer system further includes M arithmetic devices, wherein M is an integer of 2 or more, and the arithmetic processing method further comprises distributing, by the transmission control device, the data collected from the N data output devices to the M arithmetic devices on a basis of load information of the arithmetic device.
